(19) United States
(12) Patent Application Publication
(10) Pub. No.: US 2008/0024682 A1
(43) Pub. Date: Jan. 31, 2008

(54) Touchpad remote controller and control method by using the same

(76) Inventor: Cha-Hum Chen, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/878,810

(22) Filed: Jul. 27, 2007

(30) Foreign Application Priority Data
Jul. 28, 2006 (TW) 095127819

(51) Int. Cl. H04N 5/44

(52) U.S. Cl. 348/734

(57) ABSTRACT

A remote controller has a touchpad for users to operate thereon, so as to remotely control an under controlled apparatus. By recognizing the features of the operations on the touchpad, the remote controller could determine corresponding control signals to command the under controlled apparatus to start up and end off functions, adjust parameters, or input alphanumeric characters.

### FIELD OF THE INVENTION

The present invention is related generally to a remote controller and, more particularly, to a touchpad remote controller.

### BACKGROUND OF THE INVENTION

Remote controllers have been used on almost all the electronic appliances such as televisions, air conditions, audios, and electric fans for a long time. They are also used on various under electrically controlled devices such as toys and motor-driven doors. Recently, there is a tendency to integrate different electronic appliances and digital devices together, for example the proposal of home entertainment center. Microsoft Corporation further develops a Windows system of Media Center Edition (MCE) to provide multimedia play and humanity operational interface, so that the users may enjoy the digital entertainment amusements such as pictures, music, television programs, movies, home videos, radio programs, and worldwide television programs and services by using a remote controller. This integration tendency makes remote controllers become more important, and no matter for the traditional electronic appliances or new integration systems, a remote controller is always needed as the interface between the users and machines. However, the present technology development only focuses on the host side improvement and ignores the inconvenience of the remote controller. For example, around twenty buttons are provided on a typical television remote controller and occupy most of the area on the panel of the typical television remote controller. If the size of the typical television remote controller is reduced, the buttons thereon would be so close to each other and become difficult to operate. On the contrary, if the buttons are larger or with wider space to each other, the remote controller would have a bigger size. In an integration system, for controlling more media apparatus, the remote controller needs more buttons, for example including power switch button, volume adjusting buttons, channels choosing buttons, number buttons, jumping button, selection buttons for different media functions, operation buttons for each single media function, buttons for moving up, down, left, right, playing, rewind, forward, stop, and recording, etc. It is very unfriendly for users to find the needed button from so many buttons and to keep away from pressing other buttons at the same time.

One way to decrease the number of buttons is to integrate several different functions into some common buttons, for example, the function buttons and the direction buttons are provided on a display for users to choose a media or a function item therefrom. However, the users have to operate the buttons again and again to open menus layer by layer in order to select an item or a function, especially when the functions of the system or media become more and more varied and complicated, the multi-layer menus operation becomes more and more unfriendly, and the users may need dexterous hands and several actions simply for only a control purpose. Even though with this integration way, there are still 25 to 30 buttons, and the operation becomes very complex and causes error operation easily. This complex operation usually obstructs the users who are not skilled on operating a remote controller, such as aged persons, children, persons with poor eyesight or hurt hand, and who are not familiar to operate computers.

Operating by using buttons also hinders the users from controlling some functions. When using a remote controller to adjust a trumpet volume, for example, after the user presses a volume up/down button first, a volume bar appears on a display and the trumpet volume increases or decreases one unit when the user presses the button each time. If the user keeps pressing the button, the trumpet volume would change at a steady speed. Channel choosing is also the same situation. When using a remote controller to adjust brightness, contrast, or color of a display, the user must operate the corresponding buttons to enter a specific function and call out an adjusting bar, and then press an up/down button, for increasing or decreasing the volume with one unit per each pressing on a button. If the button is sustained pressed, the parameter would change at a steady speed, and this operation way cannot adjust the parameter to a target quickly. Another adjusting way is to operate a corresponding button to enter a specific function, and then press the number buttons to input a number and wait for a while for the input effective. This operation way is usually used to choose a channel directly, but has to move a finger and search the buttons.

The integration of household appliances and media apparatus increases the using frequency of the remote controller and therefore, the inherent disadvantages of remote controllers become more notable.

Another disadvantage of remote controllers is easily to break. Because the buttons are of mechanical structures, they not only have great volume and thickness, but also are damageable and easily to break.

One more disadvantage of remote controllers is the high cost, this is because the button module has a higher cost and the shell of a remote controller must have holes for the buttons to pass through, and causes the high production cost.

With MCE becoming popular and the applications of remote controller becoming wider, it is desired a more friendly remote controller.

### SUMMARY OF THE INVENTION

One object of the present invention is to provide a touchpad remote controller and a control method of using such remote controller.

Another object of the present invention is to provide a humanity remote controller and control method.

According to the present invention, a method of using a remote controller is to provide a touchpad for user's finger to operate thereon, and so produce a corresponding control signal to control an under controlled apparatus to adjust a parameter thereof or input alphanumeric characters thereto.

By detecting a landing touch on a defined area on the touchpad, a corresponding function of the under controlled apparatus is started up.

The sliding direction of a slide on the touchpad is detected to control the direction of changing a parameter or an alphanumeric character for the under controlled apparatus.

The distance of a slide on the touchpad is detected to control a speed of changing a parameter or an alphanumeric character for the under controlled apparatus.

The trace written on the touchpad is recognized to determine a parameter or an alphanumeric character for the under controlled apparatus.

The leaving from the touchpad is detected to end off a function of the under controlled apparatus.

Since a touchpad is used on a remote controller as an operation interface, the remote controller has a smaller size, lower cost, and longer lifetime than conventional remote controllers. All the operations to an inventive remote controller are carried out by a touchpad but not buttons, and the use of the remote controller becomes more friendly.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 pictures the manipulating of an under controlled apparatus by a touchpad remote controller according to the present invention;

FIG. 2 shows a first method for manipulating an under controlled apparatus by a touchpad remote controller according to the present invention;

FIG. 3 shows a second method for manipulating an under controlled apparatus by a touchpad remote controller according to the present invention;

FIG. 4 shows a third method for manipulating an under controlled apparatus by a touchpad remote controller according to the present invention;

FIG. 5 pictures an operation image when the method of FIG. 4 is used;

FIG. 6 shows a fourth method for manipulating an under controlled apparatus by a touchpad remote controller according to the present invention;

FIG. 7 pictures an operation image when the method of FIG. 6 is used;

FIG. 8 shows a fifth method for manipulating an under controlled apparatus by a touchpad remote controller according to the present invention; and

FIG. 9 shows a functional block diagram of a touchpad.

### DETAILED DESCRIPTION OF THE INVENTION

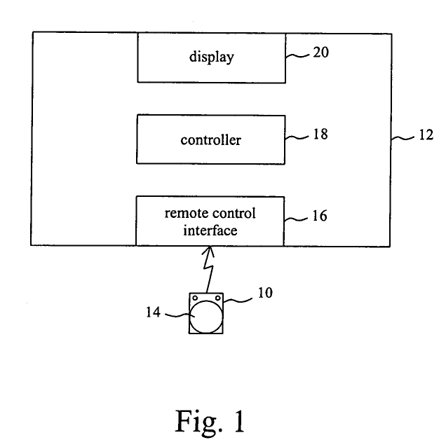

FIG. 1 pictures the manipulating of an under controlled apparatus 12 by a touchpad remote controller 10 according to the present invention. The touchpad remote controller 10 may be an apparatus only to provide remote control of the under controlled apparatus 12 or any other portable apparatus equipped with a remote control function, such as Personal Digital Assistant (PDA), cellular phone, tablet computer, keyboard, or computer mouse. The under controlled apparatus 12 may be a personal computer, server, set-top box or any other individual or integration system. The touchpad remote controller 10 has a touchpad 14 for users to operate thereon, such as touch or slide, when they are to control the under controlled apparatus 12. The features of the operations on the touchpad 14 are recognized to determine changing information to embedded in a control signal produced by the touchpad remote controller 10 to send to the under controlled apparatus 12. The under controlled apparatus 12 has a remote control interface 16 to receive the control signal come from the touchpad remote controller 10, and a controller 18 to carry out the functions according to the received control signals. The controller 18 may be a device based on microprocessor, microcontroller or other programmable apparatus, and may run an operating system such as Windows XP, Windows CE, Windows MCE, other Windows operating system, or a Linux operating system. The controller 18 receives commands from the touchpad remote controller 10 through the remote control interface 16, and dominants the functions including the interpretation of the user's input from the remote controller interface 16. According to the user's input, the controller 18 starts up a corresponding function and displays a user interface on a display 20. The user interface may be a control bar, a picture, a window, a menu, or any other visible image on the display 20. In an embodiment, the slide of the user's finger on the touchpad 14 is detected to adjust a parameter of the under controlled apparatus 12 or input an alphanumeric character to the under controlled apparatus 12, for example to adjust volume, contrast, brightness, and playing speed, to choose a channel, or to open, close, start, pause, stop, rewind, forward, backward, upward, downward, record, pop up, or switch on a menu, or to input a phone number, password, or any other code. The user may also end off a function by operating on the touchpad 14, or let the under controlled apparatus 12 end off a function after an input is completed for a while.

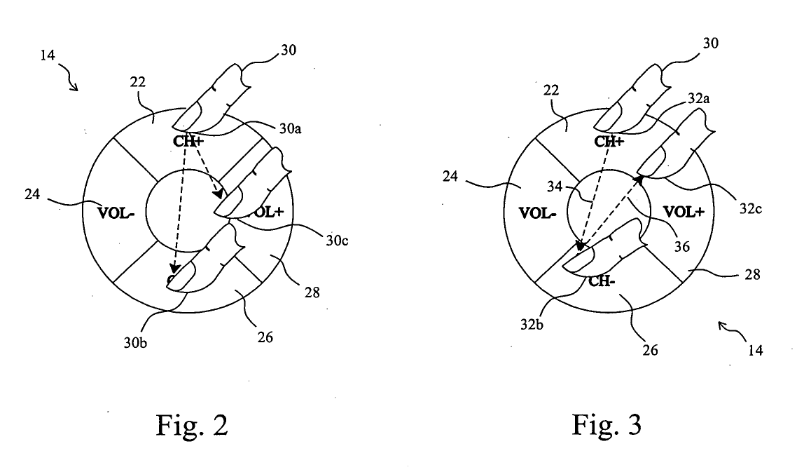

FIG. 2 shows a first method for manipulating the under controlled apparatus 12 by the touchpad remote controller 10 according to the present invention. The touchpad 14 has four defined button areas, including two channel choosing buttons 22 and 26 and two volume adjusting buttons 24 and 28, and the pictures of CH+, CH−, VOL+, and VOL− are printed on the defined button areas 22-28 to indicate channel up, channel down, volume up and volume down for users. When the touchpad 14 detects a user's finger 30 landing thereon, it produces and sends a control signal to the under controlled apparatus 12 to start up a corresponding function. For example, the user's finger 30 puts on the channel up button area 22 first, the channel up function is started up on the under controlled apparatus 12, and the current channel number is displayed on the display 20. Then the touchpad 14 measures the distance of the slide of the user's finger 30 on the touchpad 14 and accordingly, determines an increasing speed of the channel number, for example, the increasing speed is proportional to the sliding distance. As shown in FIG. 2, the distance from a start position 30a to a position 30b is longer than that from the start position 30a to a position 30c, so the increasing speed of the former is faster. In other words, the speed to change a channel is changeable. The user may roughly determine a sliding distance of his finger 30 on the touchpad 14 according to the gap between the current channel and the target channel. Once the user's finger 30 leaves the touchpad 14, a control signal is produced and sent to the under controlled apparatus 12 to end off the channel up function. Similarly, if the user's finger 30 puts on the volume down button 24 first, the volume down function is started up and the volume decreasing speed of the under controlled apparatus 12 is determined by the sliding distance between the landing position of the user's finger 30 and the stop position of the user's finger 30 after it moves.

FIG. 3 shows a second method for manipulating the under controlled apparatus 12 by the touchpad remote controller 10 according to the present invention. The user's finger 30 landing on the channel up button area 22 starts up the channel up function. Then, the user's finger 30 slides from the start position 32a to a position 32b and therefore, the increasing speed of the channel number is determined by the distance between the positions 32a and 32b. If the user's finger 30 stays at the position 32b, the under controlled apparatus 12 will tune the channel upwise at the same speed. If the user's finger 30 further slides to a position 32c approximately in the reverse direction, the channel up function changes to the channel down function, and the decreasing speed of the channel number is determined by the distance from the position 32b to the position 32c. The direction of tuning the channel up and down is determined by the direction between two slides. For example, a threshold angle of 90° is set in advance. If the included angle between the second sliding direction 36 and the first sliding direction 34 is greater than 90°, the channel tuning direction is reversed. Alternatively, it may set a reference angle of 180° and an error range of 45° in advance. If the included angle between the second sliding direction 36 and the first sliding direction 34 is between 135° and 225°, the channel tuning direction will be reversed. Therefore, each sliding direction will be compared with the last sliding direction. If the comparison result matches to the pre-set condition, the channel tuning direction would be reversed. Once the user's finger 30 leaves the touchpad 14, a control signal is produced and sent to the under controlled apparatus 12 to end off the channel tuning function. The method of adjusting volume is the same process, too.

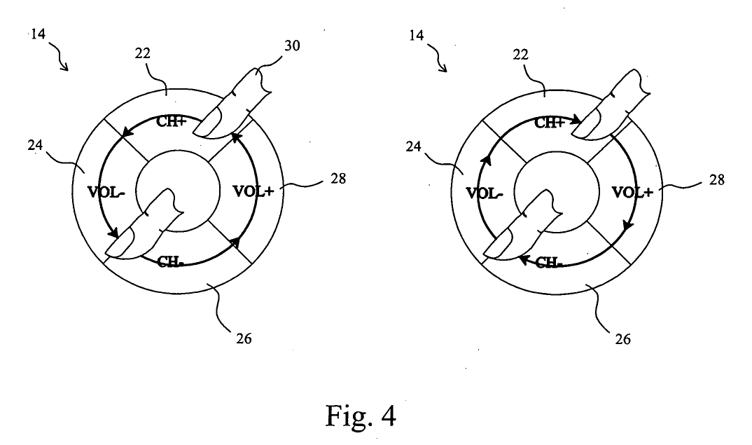

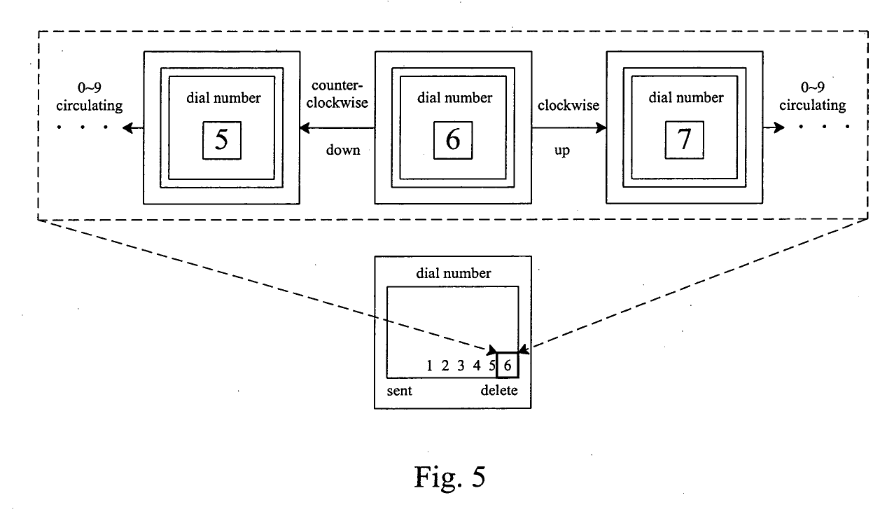

FIG. 4 shows a third method for manipulating the under controlled apparatus 12 by the touchpad remote controller 10 according to the present invention, which uses an operational way similar to a disk telephone to input an alphanumeric character. After the touchpad remote controller 10 commands the under controlled apparatus 12 to start up an alphanumeric character input function in response to a landing touch on the touchpad 14, the circular sliding of the user's finger 30 on the touchpad 14 will commands the under controlled apparatus 12 to choose an alphanumeric character for input thereto. For example, a group of alphanumeric characters is stored in the touchpad remote controller 10 or the under controlled apparatus 12 in advance, and the direction of the circular slide on the touchpad 14 is detected to move the selection of an alphanumeric character forward or backward in the group of the alphanumeric characters. For example, FIG. 5 pictures an operation image when the method of FIG. 4 is used. In this embodiment, the Arabic numerals 0 to 9 are stored in advance, and after starting up the alphanumeric character input function, the under controlled apparatus 12 displays an initial number on the display 20, for example the Arabic number 6. If the user's finger 30 slides on the touchpad 14 counterclockwise, the selected number moves down from the Arabic number 6. On the contrary, if the user's finger 30 slides on the touchpad 14 clockwise, the selected number moves up from the Arabic number 6. Further, it may set the center of the touchpad 14 as a reference point and determine the moving speed of the Arabic numerals 0 to 9 according to the distance between the position of the user's finger 30 and the reference point on the touchpad 14. Referring to FIGS. 4 and 5, when the user's finger 30 circularly slides on the touchpad 14 to move the numeral up or down with circulating the Arabic numerals 0 to 9, a square frame is moved to trap on the current numeral at the speed determined by the current distance between the user's finger 30 and the center of the touchpad 14, and once the user's finger 30 leaves the touchpad 14, the numeral within the square frame would be chosen. After a telephone number is inputted into the under controlled apparatus 12 by repeating the foregoing steps, the touchpad remote controller 10 is further used to command the under controlled apparatus 12 to dial the telephone number.

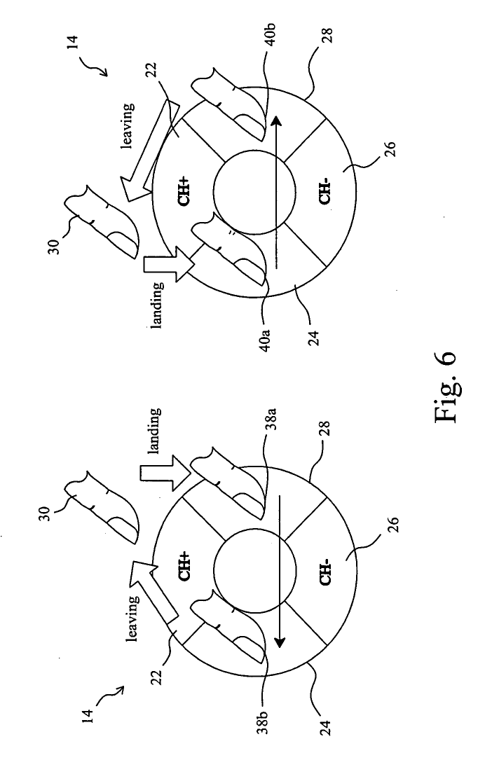

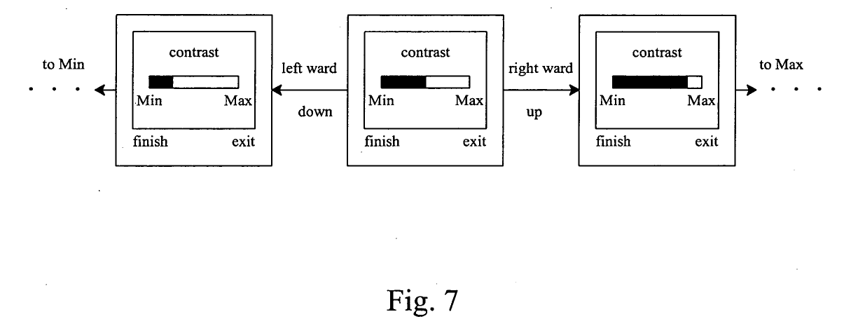

FIG. 6 shows a fourth method for manipulating the under controlled apparatus 12 by the touchpad remote controller 10 according to the present invention. The user's finger 30 slides leftward or rightward on the touchpad 14 to adjust a parameter for the under controlled apparatus 12, such as the contrast of the display 20. After the touchpad remote controller 10 commands the under controlled apparatus 12 to start up a contrast adjusting function and a contrast bar is displayed on the display 20, as shown in FIG. 7, the value of the contrast may be tuned between minimum Min and maximum Max. Referring to FIGS. 6 and 7, if the user's finger 30 slides from a position 38a to a position 38b, the contrast value decreases from the current value toward the minimum Min. On the contrary, if the user's finger 30 slides from a position 40a to a position 40b, the contrast value increases from the current value toward the maximum Max. If the user's finger 30 slides on the touchpad 14 at a time can not reach a target contrast, the same direction sliding could repeat until the adjusting of the contrast ends off. As shown in the right side of FIG. 6, after the user's finger 30 slides to the right end of the touchpad 14, the user's finger 30 leaves the touchpad 14 and then lands on the position 40a again to proceed a second sliding toward the position 40b. In different embodiments, to move on a contrast bar, the operational direction on the touchpad remote controller 10 may be up and down, or other sliding directions, depending on the programmed firmware in the touchpad 14.

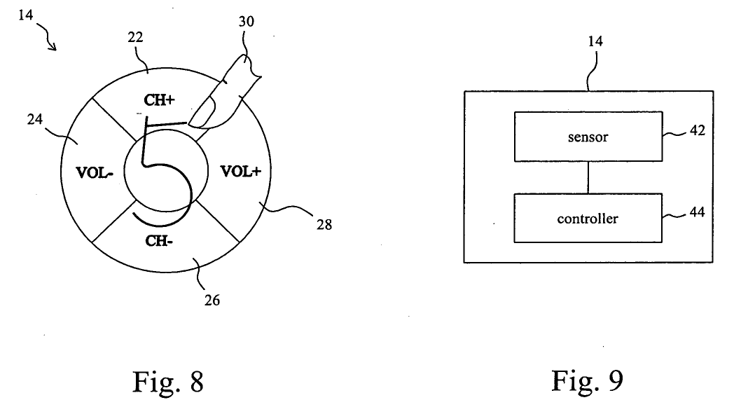

FIG. 8 shows a fifth method for manipulating the under controlled apparatus 12 by the touchpad remote controller 10 according to the present invention. Different from the foregoing embodiments, this embodiment does not adjust a parameter sequentially. In particular, an alphanumeric character is directly written on the touchpad 14 to change the parameter. For example, when choosing a channel or inputting a telephone number, after the touchpad remote controller 10 commands the under controlled apparatus 12 to start up the corresponding function, the touchpad 14 recognizes a trace on the touchpad 14 written by the user's finger 30 to produce a number to send to the under controlled apparatus 12. The under controlled apparatus 12 may also display the trace on the display 20, and switches to the corresponding channel or receives the telephone number according to the written number recognized from the trace.

According to the present invention, by recognizing the features of landing touch on the touchpad 14, sliding direction and sliding distance of a slide on the touchpad 14, and leaving from the touchpad 14, an easier operation way is provided for the users to carry out all the adjusting and input function that a remote controller can do.

FIG. 9 is a functional block diagram of the touchpad 14, which comprises a touch-sensor 42 for producing an electrical variation in response to a user's input operation, and a controller 44 for recognizing the electrical variation to produce a corresponding control signal. The hardware circuit of the touchpad 14 is well known, and the functions of the touchpad 14 are usually decided by the firmware programmed in the controller 44. Changing the firmware will change the way of how the touchpad 14 produces the corresponding control signal in response to the user's input operation. The button areas 22 to 28 in the above embodiments are defined by the firmware programmed in the controller 44 in advance, and furthermore, the detection of a touches, a position and any other operation carried out by the user's finger, the determination of a sliding direction, the measurement of a sliding distance, the comparison with a reference value or threshold value, and the production of a control signal according to the comparison, all could be carried out by the programmed firmware in the controller 44 in advance, too.

Although the way of how the touchpad remote controller 10 produces the control signals is different from conventional remote controllers, the user's interface produced on the display 12 of the under controlled apparatus 12 could be the same as conventional remote controllers, such as conventional volume bar, contrast bar, brightness bar, icon, pattern, menu of function list, and program list. If the under controlled apparatus 12 is a computer or the controller 18 runs a Windows operating system, the user's interface of Windows operating system or other user's interfaces supporting Windows operating system, such as file manager and function menu in a tree still can be used on the under controlled apparatus 12. However, to operate with the touchpad remote controller 14 would be easier, more convenient, and make less error than with physical buttons.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A method for remotely manipulating an under controlled apparatus by a remote controller including a touchpad thereon, the touchpad having a defined area corresponding to a function of the under controlled apparatus, the method comprising the steps of:
producing a first signal in response to a landing touch on the defined area for commanding the under controlled apparatus to start up the function;
recognizing a feature of a slide on the touchpad after the landing touch for determining a changing information; and
producing a second signal including the changing information for commanding the under controlled apparatus to adjust a parameter of the function.

2. The method of claim 1, wherein the feature comprises a distance of the slide for controlling a changing speed of the parameter.

3. The method of claim 2, wherein the changing speed is proportional to the distance.

4. The method of claim 1, wherein the feature comprises a direction of the slide for controlling a changing direction of the parameter.

5. The method of claim 4, wherein the changing direction of the parameter is reversed once the direction of the slide has a change matching to a preset condition.

6. The method of claim 5, wherein the preset condition comprises that the slide has changed by an angle greater than a threshold.

7. The method of claim 5, wherein the preset condition comprises that the slide has changed to a substantially reverse direction.

8. The method of claim 1, wherein the parameter is used to control a volume bar interface.

9. The method of claim 1, wherein the parameter is used to control a contrast bar interface.

10. The method of claim 1, wherein the parameter is used to control a brightness bar interface.

11. The method of claim 1, wherein the parameter is used to control a color bar interface.

12. The method of claim 1, wherein the parameter is used to control a playing speed.

13. The method of claim 1, wherein the parameter is used to choose a channel.

14. The method of claim 1, further comprising the step of producing a third signal in response to a leaving from the touchpad for commanding the under controlled apparatus to end off the function.

15. A method for remotely manipulating an under controlled apparatus by a remote controller having a touchpad thereon, the method comprising the steps of:
producing a first signal for commanding the under controlled apparatus to start up a function;
entering an alphanumeric character selection state in response to a landing touch on the touchpad;
changing an alphanumeric character in response to a circular slide on the touchpad at the alphanumeric character selection state; and
producing a second signal in response to a leaving from the touchpad for determining an alphanumeric character input with the changed alphanumeric character.

16. The method of claim 15, further comprising the step of giving an initial alphanumeric character after the step of entering an alphanumeric character selection state, such that the alphanumeric character will be changed therefrom in the step of changing an alphanumeric character.

17. The method of claim 16, wherein the alphanumeric character is changed by sequentially circulating a group of members.

18. The method of claim 17, wherein the group of members comprises Arabic numerals 0 to 9.

19. The method of claim 15, wherein the circular slide comprises a sliding direction for determining a direction of changing the alphanumeric character.

20. The method of claim 15, further comprising the step of measuring a distance variation between the circular slide and a reference point for determining a speed of changing the alphanumeric character.

21. The method of claim 20, wherein the speed of changing the alphanumeric character becomes higher when the circular slide is closer to the reference point.

22. The method of claim 15, further comprising the step of producing a third signal at the alphanumeric character selection state for commanding the under controlled apparatus to display the changing of the alphanumeric character.

23. The method of claim 15, wherein the alphanumeric character input is used to control a volume bar interface.

24. The method of claim 15, wherein the alphanumeric character input is used to control a contrast bar interface.

25. The method of claim 15, wherein the alphanumeric character input is used to control a brightness bar interface.

26. The method of claim 15, wherein the alphanumeric character input is used to control a color bar interface.

27. The method of claim 15, wherein the alphanumeric character input is used to control a playing speed.

28. The method of claim 15, wherein the alphanumeric character input is used to choose a channel.

29. The method of claim 15, wherein the alphanumeric character input is used to choose an item in a menu.

30. The method of claim 15, wherein the alphanumeric character input is used to decide a telephone number.

31. The method of claim 15, further comprising the step of producing a third number for commanding the under controlled apparatus to end off the function.

32. A method for remotely manipulating an under controlled apparatus by a remote controller having a touchpad thereon, the method comprising the steps of:
producing a first signal for commanding the under controlled apparatus to start up a function;
recognizing a sliding direction of a slide on the touchpad substantially in a defined direction for determining a changing direction; and
producing a second signal including an changing direction information for commanding the under controlled apparatus to adjust a parameter with the changing direction.

33. The method of claim 32, wherein the defined direction is substantially in a horizontal direction.

34. The method of claim 32, wherein the defined direction is substantially in a vertical direction.

35. The method of claim 32, wherein the defined direction is either one of two reverse directions in a straight line.

36. The method of claim 35, wherein the two reverse directions define a direction of adjusting the parameter in two reverse directions.

37. The method of claim 32, wherein the parameter is adjusted within a preset range.

38. The method of claim 32, wherein the parameter is used to control a volume bar interface.

39. The method of claim 32, wherein the parameter is used to control a contrast bar interface.

40. The method of claim 32, wherein the parameter is used to control a brightness bar interface.

41. The method of claim 32, wherein the parameter is used to control a color bar interface.

42. The method of claim 32, wherein the parameter is used to control a playing speed.

43. The method of claim 32, wherein the parameter is used to choose a channel.

44. The method of claim 32, wherein the slide comprises at least two times of a landing touch on the touchpad followed with a moving on the touchpad in substantially a same direction.

45. The method of claim 32, further comprising the step of producing a third signal for commanding the under controlled apparatus to end off the function.

46. A method for remotely manipulating an under controlled apparatus by a remote controller having a touchpad thereon, the method comprising the steps of:
producing a first signal for commanding the under controlled apparatus to start up a function;
recognizing a trace applying on the touchpad for determining an alphanumeric character; and
producing a second signal including the alphanumeric character for commanding the under controlled apparatus to adjust a parameter with the alphanumeric character.

47. The method of claim 46, further comprising the step of producing a third signal for commanding the under controlled apparatus to display the trace.

48. The method of claim 46, wherein the alphanumeric character is used to control a volume bar interface.

49. The method of claim 46, wherein the alphanumeric character is used to control a contrast bar interface.

50. The method of claim 46, wherein the alphanumeric character is used to control a brightness bar interface.

51. The method of claim 46, wherein the alphanumeric character is used to control a color bar interface.

52. The method of claim 46, wherein the alphanumeric characters is used to control a playing speed.

53. The method of claim 46, wherein the alphanumeric character is used to choose a channel.

54. The method of claim 46, wherein the alphanumeric character is used to choose an item in a menu.

55. The method of claim 46, wherein the alphanumeric character is used to decide a telephone number.

56. The method of claim 46, further comprising the step of producing a third signal for commanding the under controlled apparatus to end off the function.

57. A touchpad remote controller for remotely manipulating an under controlled apparatus, comprising:
a touch-sensor for producing an electrical variation in response to an input operation, the touch-sensor having an area pre-defined corresponding to a function of the under controlled apparatus; and
a controller coupled to the touch-sensor for recognizing the electrical variation to produce a corresponding control signal;
wherein the controller commands the under controlled apparatus by the control signal, to start up the function in response to a landing touch on the area, to adjust a parameter of the function in response to a slide on the touchpad, and to end off the function in response to a leaving from the touchpad.

58. The touchpad remote controller of claim 57, wherein the controller measures a distance of the slide for controlling a changing speed of the parameter.

59. The touchpad remote controller of claim 58, wherein the changing speed of the parameter is proportional to the distance.

60. The touchpad remote controller of claim 57, wherein the controller detects a direction of the slide for controlling a changing direction of the parameter.

61. The touchpad remote controller of claim 60, wherein the changing direction of the parameter is reversed once the direction of the slide has a change matching to a preset condition.

62. The touchpad remote controller of claim 61, wherein the preset condition comprises that the slide has changed by an angle greater than a threshold.

63. The touchpad remote controller of claim 61, wherein the preset condition comprises that the slide has changed to a substantially reverse direction.

64. A touchpad remote controller for remotely manipulating an under controlled apparatus, comprising:
a touch-sensor for producing an electrical variation in response to an input operation; and
a controller coupled to the touch-sensor for recognizing the electrical variation to produce a corresponding control signal;
wherein, in a function of the under controlled apparatus, the controller enters an alphanumeric character selection state in response to a landing touch on the touch-sensor, changes an alphanumeric character in response to a circular slide on the touch-sensor, and determines an alphanumeric character input with the alphanumeric character in response to a leaving from the touch-sensor.

65. The touchpad remote controller of claim 64, wherein the controller detects a sliding direction of the circular slide for determining a direction of changing the alphanumeric character.

66. The touchpad remote controller of claim 64, wherein the controller measures a distance variation between the circular slide and a reference point for determining a speed of changing the alphanumeric character.

67. The touchpad remote controller of claim 66, wherein the controller changes the alphanumeric character with higher speed when the circular slide is closer to the reference point.

68. A touchpad remote controller for remotely manipulating an under controlled apparatus, comprising:
a touch-sensor for producing an electrical variation in response to an input operation; and
a controller coupled to the touch-sensor for recognizing the electrical variation to produce a corresponding control signal;
wherein, in a function of the under controlled apparatus, the controller recognizes a sliding direction of a slide on the touch-sensor substantially in a defined direction and accordingly, commands the under controlled apparatus to adjust an parameter with a changing direction.

69. The touchpad remote controller of claim 68, wherein the defined is substantially in a horizontal direction.

70. The touchpad remote controller of claim 68, wherein the defined direction is substantially in a vertical direction.

71. The touchpad remote controller of claim 68, wherein the defined direction is either one of two reverse directions in a straight line.

72. The touchpad remote controller of claim 68, wherein the two reverse directions define a direction of adjusting the parameter in two reverse directions.

73. A touchpad remote controller for remotely manipulating an under controlled apparatus, comprising:
a touch-sensor for producing an electrical variation in response to an input operation; and
a controller coupled to the touch-sensor for recognizing the electrical variation to produce a corresponding control signal;
wherein, in a function of the under controlled apparatus, the controller recognizes a trace applying on the touch-sensor for determining an alphanumeric character to provide for the under controlled apparatus to adjust a parameter.

74. The touchpad remote controller of claim 73, wherein the controller sends the trace to the under controlled apparatus to display.
